(19) United States
(12) Patent Application Publication
(10) Pub. No.: US 2026/0077538 A1
(43) Pub. Date: Mar. 19, 2026

(54) METHOD AND APPARATUS FOR MAKING OBJECTS WITH A COMPOSITE MATERIAL COMPRISING A NATURAL MATERIAL

(71) Applicant: SACMI COOPERATIVA MECCANICI IMOLA SOCIETA' COOPERATIVA, Imola (Bologna) (IT)

(72) Inventors: Fabrizio Pucci, Imola (Bologna) (IT); Fiorenzo Parrinello, Imola (Bologna) (IT)

(21) Appl. No.: 19/107,878

(22) PCT Filed: Aug. 30, 2023
(86) PCT No.: PCT/IB2023/058579

§ 371 Date: Feb. 28, 2025

(30) Foreign Application Priority Data
Aug. 31, 2022 (IT) 102022000017838

(51) Int. Cl. B29B 7/00; B29B 7/72; B29B 7/82; B29C 43/00; B29C 48/00; B29C 48/385; B29C 48/82; B29K 201/00; B29L 31/00

(52) U.S. Cl. CPC B29B 7/007; B29B 7/726; B29B 7/826; B29C 43/003; B29C 48/0011; B29C 48/022; B29C 48/385; B29C 48/82; B29K 2201/00; B29K 2995/004; B29L 2031/712

(57) ABSTRACT

A method for making an object with a composite material that includes at least one polymeric material in which a material of natural origin is dispersed. The method includes the steps of extruding the polymeric material in an extrusion stage; adding the material of natural origin to the polymeric material, thereby obtaining the composite material; and pressing the composite material to obtain the object. The material of natural origin is added to the polymeric material after having cooled the polymeric material downstream of the extrusion stage.

The invention relates to a method and an apparatus for making objects with a composite material comprising a polymeric material to which a material of natural origin has been added. In particular, the material of natural origin may be a material derived from natural fibres, for example a material derived from wood fibres such as cellulose, lignin or the like.

Synthetic polymeric materials are widely used in the packaging sector. However, for reasons linked to environmental protection, there is a strong need to substitute synthetic polymeric materials with materials of natural origin, for example cellulose-based materials.

There are many applications in which substituting the synthetic polymeric material with a natural material is not yet possible, for example due to finished object performance required, or for reasons linked to the production process which must be used to obtain the finished object. In these cases, it would be desirable to succeed in substituting at least part of the polymeric material with a material of natural origin.

Therefore, the idea of using composite materials having a matrix formed by a synthetic polymer, in which fibres of natural origin are dispersed was devised. However, that brings considerable production difficulties, above all due to the risks of damaging the fibres of natural origin during the production process.

An object of the invention is to improve the methods and apparatuses for making objects with a composite material comprising at least one polymeric material and one material of natural origin.

A further object is to provide the apparatuses and the methods for making objects with a composite material comprising at least one polymeric material and one material of natural origin, in which the risks of damaging the material of natural origin while the objects are made are reduced.

Another object is to provide a method and an apparatus which allow objects to be made which are of good quality, with a lower environmental impact than objects made entirely with synthetic polymeric materials.

Another object is to provide a method and an apparatus for making objects with a composite material comprising at least one polymeric material and one material of natural origin, which have good productivity.

In a first aspect of the invention, there is provided a method for making an object with a composite material comprising at least one polymeric material in which a material of natural origin is dispersed, the method comprising the steps of:
extruding the polymeric material in an extrusion stage to obtain a flow of polymeric material;
adding the material of natural origin to the flow of polymeric material, thereby obtaining the composite material;
pressing the composite material to obtain the object,
   wherein the material of natural origin is added to the flow of polymeric material after having cooled the polymeric material downstream of the extrusion stage.

Owing to this aspect of the invention, objects which were traditionally made only with synthetic polymeric materials can be made with a composite material which also comprises a material of natural origin, which allows a reduction in the environmental impact of the finished object. The method according to the first aspect of the invention allows the object to be made without damaging the material of natural origin. In fact, before adding the material of natural origin, the polymeric material which has been plasticised in the extrusion stage is cooled to a temperature lower than the extrusion temperature of the polymeric material in the extrusion stage, but at which the polymeric material can in any case be formed by pressing, to obtain the object. In this way the temperature of the polymeric material may be brought to a value which the material of natural origin can withstand without degrading. In this way a good quality object is obtained.

Forming by pressing also allows a reduction in the internal stresses and frictions generated in the composite material, which helps to keep its temperature limited.

Moreover, forming by pressing can be performed in line with extrusion of the polymeric material, which makes it possible to obtain the object with a high production speed.

The production speed is also increased because the object is formed after the polymeric material has already been partially cooled, which makes it possible to cool the object more quickly after forming and therefore reduces the cycle time.

In one embodiment, the polymeric material is an amorphous polymer having a glass transition temperature.

In this embodiment, the material of natural origin may be added to the polymeric material after having cooled the polymeric material, downstream of the extrusion stage, to a temperature higher than the glass transition temperature of the amorphous polymer.

In particular, in the extrusion stage the amorphous polymer may be brought to an extrusion temperature at least 80° C. higher than the glass transition temperature.

The material of natural origin may be added to the amorphous polymer after having cooled the amorphous polymer, downstream of the extrusion stage, to a working temperature at least 50° C. higher than the glass transition temperature.

With these values of the working temperature, the viscosity of the amorphous polymer is still low enough for it to be formed by pressing.

In an alternative embodiment, the polymeric material may comprise a semi-crystalline polymer.

The semi-crystalline polymer includes a crystalline fraction and an amorphous fraction. The crystalline fraction has a melting temperature and a crystallisation temperature. The amorphous fraction has a glass transition temperature.

In the extrusion stage, the polymeric material may be heated to a temperature higher than the melting temperature of the crystalline fraction.

The material of natural origin may be added after having cooled the polymeric material, downstream of the extrusion stage, to a temperature higher than the crystallisation temperature of the crystalline fraction.

In one embodiment, the method comprises the step of mixing the composite material, in order to evenly disperse the material of natural origin in the polymeric material.

The step of mixing the composite material may be carried out inside a twin-screw extruder.

Owing to the combined action of the two screws included in the twin-screw extruder, it is possible to obtain a particularly even dispersion of the material of natural origin in the polymeric material, mixing the material of natural origin with the polymeric material without there being a substantial increase in the temperature.

Moreover, the screws of the twin-screw extruder make it possible to feed the material of natural origin, even when the latter is in the form of natural fibres, without the fibres stopping in a fixed position during the mixing.

In one embodiment, the step of pressing the composite material to obtain the object comprises cutting a continuous flow of the composite material to obtain successive doses of composite material, and compression moulding each dose in a mould to form the object.

By means of the compression moulding, the composite material can be formed with high productivity, without excessively stressing its components.

In a second aspect of the invention, there is provided an apparatus for making an object with a composite material comprising at least one polymeric material in which at least one material of natural origin is dispersed, wherein the apparatus comprises:
an extrusion stage for extruding the polymeric material;
a cooler positioned downstream of the extrusion stage for cooling the polymeric material;
a metering unit positioned downstream of the cooler for adding the material of natural origin to the polymeric material which has been cooled, thereby obtaining the composite material;
a mixer for mixing the composite material;
a pressing device for pressing the composite material, so as to obtain the object.

Owing to the cooler, which cools the polymeric material coming from the extrusion stage, it is possible to add the material of natural origin to a polymeric material which is already partially cooled, but is still fluid enough to be pressed. In this way, the risks of damaging the material of natural origin due to the high temperatures are reduced, if not eliminated.

Consequently, it is possible to make objects containing a significant quantity of material of natural origin, which allows a reduction in the environmental impact of the finished object.

The invention may be better understood and implemented with reference to the accompanying drawings, which illustrate an example, non-limiting embodiment of it, in which:

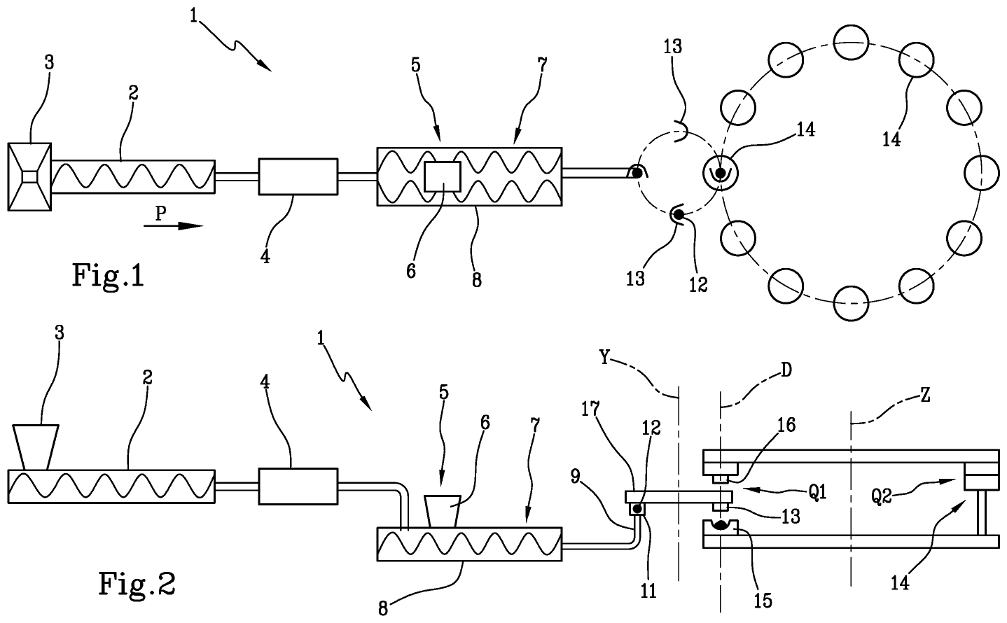

FIG. 1 is a schematic top view showing an apparatus for making objects with a composite material containing a material of natural origin;

FIG. 2 is a schematic side view of the apparatus of FIG. 1;

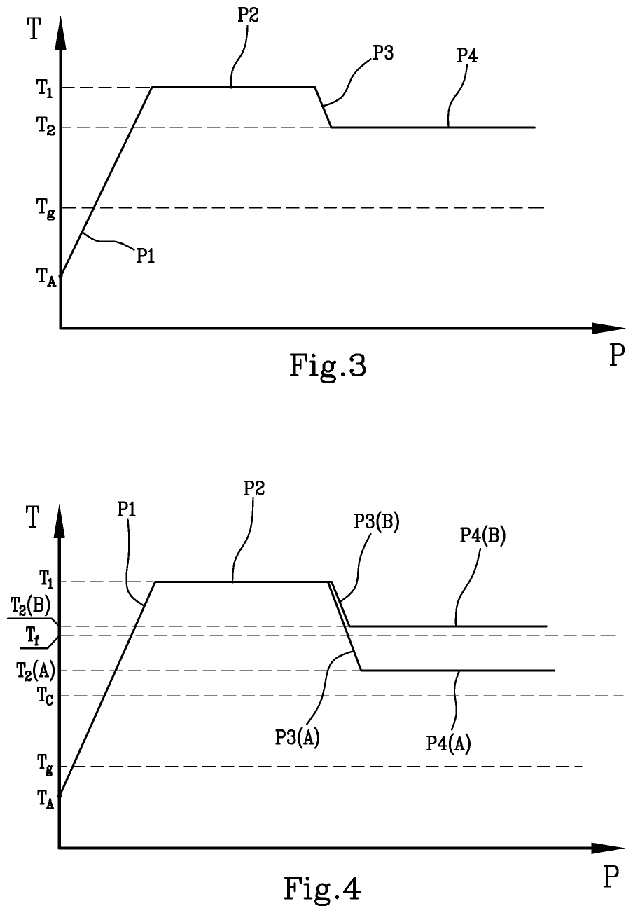

FIG. 3 is a graph schematically showing the distribution of temperatures in the apparatus of FIG. 1, in the case in which an amorphous polymer is used;

FIG. 4 is a graph like that of FIG. 3, relative to a semi-crystalline polymer;

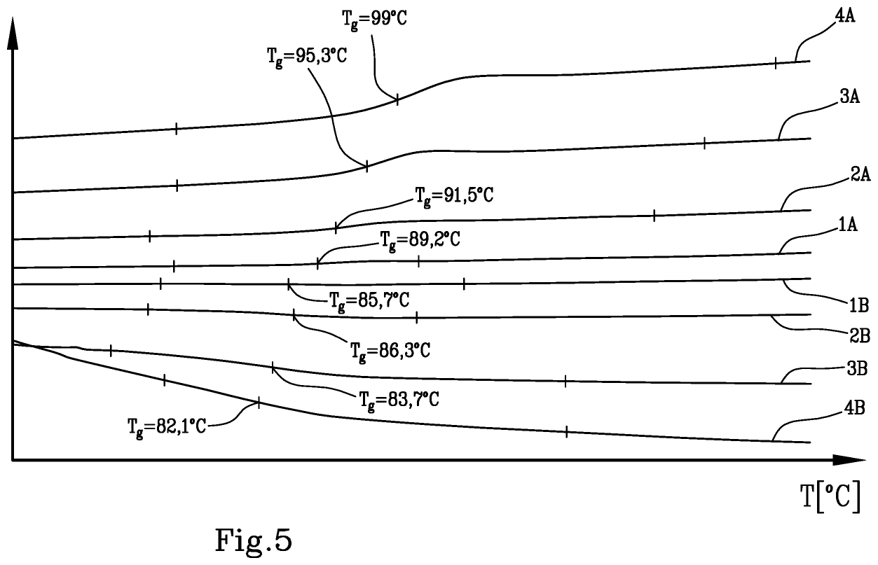

FIG. 5 is a graph which shows the results of the DSC analysis on an amorphous polymer, with different scan speed values;

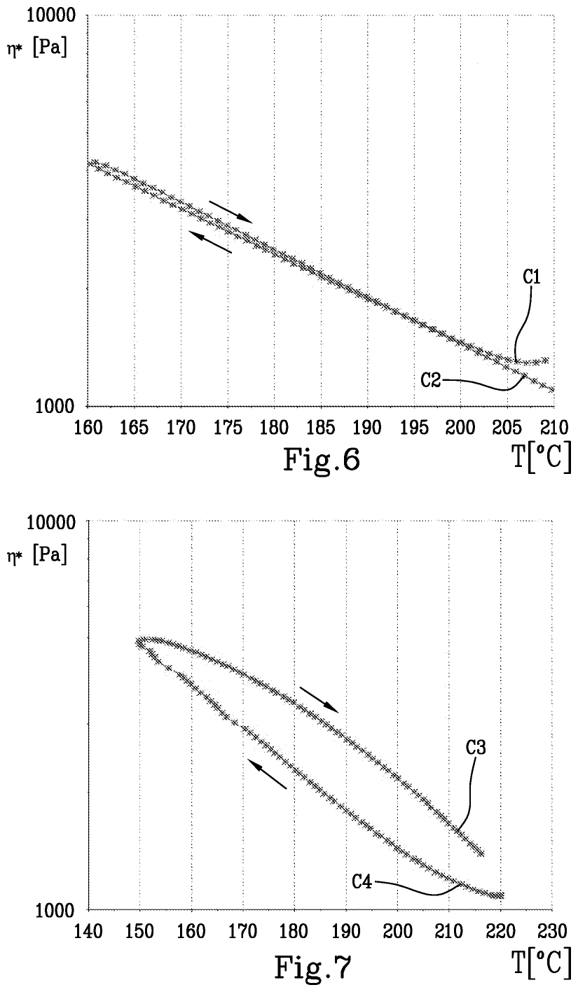

FIG. 6 is a graph showing how the viscosity varies depending on the temperature for an amorphous polymer, with a relatively low heating/cooling speed value;

FIG. 7 is a graph like that of FIG. 6, relative to a higher heating/cooling speed value.

FIGS. 1 and 2 show an apparatus 1 for making objects, for example objects intended to be used in the packaging sector. The objects made in the apparatus 1 may be objects having a concave shape, for example containers, caps for containers, capsules, preforms for containers, or the like.

The apparatus 1 allows objects to be made with a composite material comprising a polymeric matrix in which a material of natural origin is dispersed.

The polymeric matrix is a matrix formed from at least one polymeric material which may be a synthetic polymer of the type traditionally used in the packaging sector, or a biodegradable polymer. Examples of synthetic polymers traditionally used in the packaging sector include for example polyethylene (PE), polypropylene (PP), polymers of the family of polyesters, for example polyethylene terephthalate (PET). Biodegradable polymers which may be used to form the polymeric matrix include polylactic acid (PLA) and its compounds, or polysaccharides, for example polymers derived from corn.

The material of natural origin dispersed in the polymeric matrix may be a material derived from wood, for example cellulose or lignin, in the form of fibres or in the form of powder.

The term “polymeric matrix” is used to indicate the material which is first brought to the fluid state, and to which the material of natural origin is then added. The term “polymeric matrix” is not intended to introduce limitations on the quantity of the material of natural origin, which may even be present in a significant quantity.

The composite material processed by the apparatus 1 may also comprise other additives, such as dyes, lubricants and others.

The polymeric material may be an amorphous polymer or a semi-crystalline polymer.

Amorphous polymers have a characteristic temperature, called the glass transition temperature T_{g}. This temperature is the temperature at which the glass transition of the amorphous material occurs, that is to say, a solid-solid transition in which, during heating, the amorphous material passes from a glassy, rigid and fragile solid state, to a fluid solid state. In the glassy solid state, the polymeric chains of the amorphous material are substantially stationary, whilst in the fluid solid state there are short-range movements of the polymeric chains.

The glass transition occurs when, thanks to the temperature increase, the rotational movements of the kinetic units of the amorphous polymeric material are unblocked. Since, in a same material, the kinetic units may be of different types, the rotational movements are unblocked in a temperature range and therefore the glass transition occurs in a temperature range and not at a specific predetermined temperature.

Once one knows—by means of differential scanning calorimetry (DSC)—the temperature range in which the rotational movements of the kinetic units of the amorphous polymeric material are unblocked, it is possible, by means of a conventional calculation, to determine the glass transition temperature T_{g}.

The glass transition is affected by the speed of heating or of cooling of the material considered.

That is visible in FIG. 5, which shows the results of the differential scanning calorimetry (DSC) on samples of an amorphous polymeric material.

During the differential scanning calorimetry the sample was heated, kept at a constant temperature and then cooled, multiple times.

In order to study the effects, on the glass transition temperature T_{g}, of the sample heating or cooling speed, multiple scanning speeds were considered during heating and cooling (that is to say, heating or cooling speeds), as specified below:

$${v}_{1} = 5 ° C . / minute$$

$${v}_{2} = 20 ° C . / minute$$

$$v 3 = 50 ° C . / minute$$

$$v 4 = 80 ° C . / minute$$

In the testing relative to heating, sample behaviour was studied while the latter was heated from 0° C. to 200° C., for each of the speeds indicated above. In the testing relative to cooling, in contrast sample behaviour was studied during cooling from 200° C. to 0° C., for each of the preceding speeds.

FIG. 5 shows the thermograms developed, obtained from the testing described above.

The results of the testing shown in FIG. 5 have been outlined in Table 1 below, which shows that the glass transition temperature T_{g} varies with variations in the heating or cooling speed (scanning speed) used. In particular, when the sample is heated, the glass transition temperature T_{g} increases as the heating speed increases, passing from a value of 89.2° C. for a heating speed of 5° C./minute to a value of 99° C. for a heating speed of 80° C./minute.

In contrast, when the sample is cooled, the glass transition temperature T_{g} generally decreases as the cooling speed increases, passing from a value of 85.7° C. for a cooling speed of 5° C./minute to a value of 82.1° C. for a cooling speed of 80° C./minute.

TABLE 1

| | | Scanning | | | | | |
|---|---|---|---|---|---|---|---|
| Curve | | speed | Initial T | | Final T | | T_{g} |
| number | Type | [° C./minute] | [° C.] | | [° C.] | | [° C.] |
| 1A | Heating | 5 | 0° | C. | 200° | C. | 89.2 |
| 2A | Heating | 20 | 0° | C. | 200° | C. | 91.5 |
| 3A | Heating | 50 | 0° | C. | 200° | C. | 95.3 |
| 4A | Heating | 80 | 0° | C. | 200° | C. | 99 |
| 1B | Cooling | 5 | 200° | C. | 0° | C. | 85.7 |
| 2B | Cooling | 20 | 200° | C. | 0° | C. | 86.3 |
| 3B | Cooling | 50 | 200° | C. | 0° | C. | 83.7 |
| 4B | Cooling | 80 | 200° | C. | 0° | C. | 82.1 |

Moreover, as can be seen from Table 2 below, the difference between the glass transition temperature, measured during sample heating for a predetermined scanning speed, and the glass transition temperature, measured during sample cooling for the same scanning speed, increases as the scanning speed increases.

TABLE 2

| Scanning speed | ΔT_{g} = |
|---|---|
| [° C./min] | T_{g} (heating) − T_{g} (cooling) |
| 5 | 89.2 − 85.7 = 3.5° C. |
| 20 | 91.5 − 86.3 = 5.2° C. |
| 50 | 95.3 − 83.7 = 11.6° C. |
| 80 | 99 − 82.1 = 16.9° C. |

Several studies were also carried out which demonstrate how even the viscosity of an amorphous polymer is affected by the heating or cooling speed.

FIGS. 6 and 7 show how the viscosity of an amorphous polymeric material varies with variations in the temperature, for different heating or cooling speed values.

In particular, the curve C1 of FIG. 6 refers to the variation in viscosity in a sample which is heated from 160° C. to 210° C., with a heating speed of 1° C./minute. The curve C2 of FIG. 6 in contrast refers to the variation in viscosity in a sample which is cooled from 210° C. to 160° C., with a cooling speed of 1° C./minute.

The curve C3 of FIG. 7 refers to the variation in viscosity in a sample which is heated from 150° C. to 220° C., with a heating speed of 10° C./minute. The curve C4 of FIG. 7 in contrast refers to the variation in viscosity in a sample which is cooled from 220° C. to 150° C., with a cooling speed of 10° C./minute.

In all of the situations analysed, the viscosity decreases as the temperature increases. However, if the heating/cooling speed is relatively low, as in the case in FIG. 6, the variation in viscosity depending on the temperature during heating can almost be superposed on the variation in viscosity depending on the temperature during cooling.

If in contrast the heating/cooling speed is relatively high, as in the case of FIG. 7, a significant difference is noticed between the curve showing how the viscosity varies during cooling and the curve showing how the viscosity varies during heating.

In general, if the heating/cooling speed is high enough, the viscosity measured during cooling is lower than the viscosity measured during heating, for a predetermined temperature.

The temperature being equal, the difference between the viscosity measured during heating and the viscosity measured during cooling increases as the heating/cooling speed increases. Moreover, the temperature being equal, during heating the viscosity increases as the heating speed increases (that is to say, the curve showing how the viscosity varies during heating shifts upwards in a graph of the type shown in FIGS. 6 and 7), whilst during cooling the viscosity decreases as the cooling speed increases (that is to say, the curve which shows how the viscosity varies during cooling shifts downwards in a graph of the type shown in FIGS. 6 and 7).

The amorphous polymeric material therefore has a hysteresis in the viscosity trend depending on the temperature, if the behaviour of the material during heating and during cooling is compared. This hysteresis is more pronounced, the higher the heating/cooling speed is.

Therefore, the more an amorphous polymeric material is rapidly cooled, the more its viscosity decreases, for a predetermined temperature.

As mentioned above, semi-crystalline polymers have an amorphous fraction and a crystalline fraction. The amorphous fraction has a glass transition temperature T_{g}, as previously defined. The crystalline fraction in contrast has a melting temperature T_{f} and a crystallisation temperature T_{C}. The melting temperature T_{f} is the temperature at which the crystalline fraction of the semi-crystalline material, during cooling, passes from the solid state to the melted state. The crystallisation temperature T_{C} is the temperature at which the crystalline fraction of the semi-crystalline material crystallises during cooling. The crystallisation temperature T_{C} is lower than the melting temperature T_{F}.

As was previously described for the glass transition, the crystallisation and melting also do not occur at a specific temperature, but in a range of temperatures. However, it is usual practice to define a single value for the melting temperature, and for the crystallisation temperature, those values calculated in a standardised way from the relative ranges.

For a semi-crystalline material, the crystallisation temperature of the crystalline fraction is usually significantly higher than the glass transition temperature of the amorphous fraction.

The apparatus 1 comprises an extruder 2, suitable for being fed with at least one polymeric material intended to form the polymeric matrix of the composite material. The polymeric material may be inserted into the extruder 2 through a hopper 3. The polymeric material may be in the form of pellets. It is also possible to insert more than one polymeric material into the extruder 2 if the composition of the composite material requires it.

The extruder 2 may be a single-screw extruder, that is to say, having a single extrusion screw. However, this condition is not necessary and, in place of the single-screw extruder, other types of extruder may be used.

The polymeric material is fed along a path P, initially inside the extruder 2. Simultaneously, the polymeric material is heated to obtain a polymeric material in a fluid state. The screw of the extruder 2 allows the polymeric material to be homogenised from a thermal viewpoint.

The extruder 2 defines an extrusion stage in which the temperature of the polymeric material is heated until it reaches an extrusion temperature T₁.

The apparatus 1 further comprises a cooler 4, positioned downstream of the extruder 2 for cooling the continuous flow of extruded polymeric material, in such a way that the temperature of the polymeric material falls below the value of the extrusion temperature T₁ reached in the extruder 2.

The cooler 4 may comprise a heat exchanger, for example a heat exchanger having an outer jacket in which a cooling fluid circulates. The heat exchanger may operate as a counter-flow heat exchanger.

In an alternative embodiment, the cooler 4 may be included in the extruder 2, in the sense that the cooler 4 may comprise a cooling section positioned in the extruder 2 downstream of the extrusion stage.

In general, in the cooler 4 the temperature of the polymeric material is reduced to a value at which the polymeric material remains fluid enough to make the subsequent forming possible.

More specifically, the temperature to which the polymeric material is cooled in the cooler 4 may vary depending on various factors, one of which is the type of polymeric material processed.

FIG. 3 refers to the case in which the polymeric material which is processed in the apparatus 1 is an amorphous polymer and shows how the temperature of the amorphous polymer varies, shown on the y-axis, depending on the position of the amorphous polymer along the path P inside the apparatus 1. This position is shown on the x-axis.

The amorphous polymer enters the extruder 2 at an initial temperature which may be equal to the ambient temperature TA.

The stretch P1 in FIG. 3 refers to a step of heating the amorphous polymer inside the extruder 2. During this step, the temperature of the amorphous polymer is increased from the initial value, of the amorphous polymer upon entering the extruder 2, to the extrusion temperature T₁, which is higher than the glass transition temperature T_{g}.

In an example embodiment, it may be the case that T₁≥T_{g}+70° C., for example T₁≥T_{g}+80° C.

At the extrusion temperature T₁, the polymeric chains of the amorphous polymer have reached sufficient mobility for the amorphous polymer to be able to be extruded.

The temperature of the polymeric material is kept constant, equal to the value T₁, while the polymeric material is fed inside the extruder 2, as shown by the horizontal stretch P2 in FIG. 3.

In the cooler 4, the temperature of the polymeric material is reduced to a working temperature T₂ higher than the glass transition temperature T_{g} of the amorphous polymer.

More specifically, it may be the case that T₂≥T_{g}+50° C.

The temperature decrease in the cooler 4 is indicated by the stretch P3 in FIG. 3. The amorphous polymer remains at a substantially constant temperature, equal to the working temperature T₂, during the subsequent working, in particular while the amorphous polymer is shaped to obtain the object, as shown by the stretch P4 in FIG. 3.

FIG. 4 refers to the case in which the polymeric material processed in the apparatus 1 is a semi-crystalline polymer, having predetermined values for the glass transition temperature T_{g} of the amorphous fraction and for the crystallisation temperature T_{C} and the melting temperature T_{f} of the crystalline fraction.

In this case, the semi-crystalline polymer is heated, in the extruder 2, to an extrusion temperature T₁ higher than the melting temperature T_{f} of the crystalline fraction, as indicated by the stretch P1. The semi-crystalline polymer remains at the temperature T₁, as indicated by the stretch P2, until it enters the cooler 4.

In a first example embodiment, in the cooler 4 the semi-crystalline polymer is cooled until it reaches a working temperature T_{2(A)}, which is higher than the crystallisation temperature T_{C} of the crystalline fraction, but lower than its melting temperature T_{f}. This is indicated by the stretch P3(A) in FIG. 4, whilst the next stretch P4(A) indicates that the temperature of the amorphous polymer after cooling in the cooler 4 remains substantially constant, until the object is formed.

In a second example embodiment, it may be the case that in the cooler 4 the semi-crystalline polymer is cooled until it reaches a working temperature T_{2(B)} which, although being lower than the temperature T₁ of the material at the outfeed of the extruder 2, is still higher than the melting temperature T_{f} of the crystalline fraction. This is indicated by the stretch P3(B) in FIG. 4, whilst the next stretch P4(B) indicates that the temperature of the semi-crystalline polymer after cooling in the cooler 4 remains substantially constant, until the object is formed.

In both of the embodiments shown in FIG. 4, the working temperature reached by the semi-crystalline polymer at the outfeed of the extruder 2 is significantly higher than the glass transition temperature of the amorphous fraction, since that temperature is well below the crystallisation temperature.

The inclination of the stretch P3 in FIG. 3, like that of the stretches P3(A) and P3(B) in FIG. 4, indicates the speed of cooling of the polymeric material in the cooler 4 and, in the case of an amorphous polymer, is correlated with the apparent viscosity.

Downstream of the cooler 4, the apparatus 1 has an adding zone 5 for adding to the continuous flow of polymeric material the material of natural origin, for example the cellulose fibres or powder. The adding zone 5 may comprise a metering unit 6, of the known type, for inserting the material of natural origin into the flow of polymeric material in a dosed quantity.

In the metering unit 6, or in another metering unit placed near the metering unit 6, it is possible to also add other additives to the flow of polymeric material. Alternatively, the additives may be added to the polymeric material upstream of the metering unit 6, for example in the extruder 2, or even downstream of the latter.

The apparatus 1 also comprises a mixer 7 for mixing the continuous flow of polymeric material, to which the material of natural origin and any additives have been added, so as to obtain a chemically and thermally homogeneous composite material.

The mixer 7 may comprise a twin-screw extruder 8, that is to say, an extruder provided with two screws rotatable about respective parallel axes, for example horizontal axes, capable of evenly mixing the composite material.

The twin-screw extruder 8, in addition to guaranteeing a particularly effective mixing action thanks to the combined action of the two screws, allows processing of the composite material without excessively stressing it, so that the temperature of the composite material is kept substantially constant, that is to say, significant heat increases are avoided.

In an alternative embodiment, the mixer 7 may be of a type different from the twin-screw extruder. For example, the mixer 7 could comprise a single-screw extruder or another type of dynamic mixer.

Above all if the material of natural origin comprises fibres, it is appropriate to use a dynamic mixer, that is to say, having a rotating mixing member, capable of actively pushing the fibres forwards, preventing the fibres from stopping and blocking the mixer.

The adding zone 5 may be positioned in an initial portion of the mixer 7 relative to a direction of feed of the compound in the apparatus 1.

The mixer 7 defines a mixing stage for mixing the composite material comprising at least the polymeric material, the material of natural origin and the additives if necessary.

The mixer 7 may be thermally conditioned, for example with oil or another fluid, to keep the temperature of the compound substantially constant.

In one embodiment, the cooling stage and the mixing stage may be integrated in the extruder 2, that is to say, may be in the form of respective cooling and mixing sections which are positioned downstream of an extrusion stage of the extruder 2.

The temperature of the composite material inside the mixer 7 may remain constant, for example substantially equal to the value of the temperature of the polymeric material at the outfeed of the cooler 4, as shown by the stretch P4 in FIG. 3 or by the stretches P4(A) or P4(B) in FIG. 4.

The temperature of the composite material in the mixer 7 is lower than the degradation temperature at which the material of natural origin and/or any additives start to degrade. In this way, the material of natural origin and/or any additives are not damaged by the high temperatures, when they are added to the flow of polymeric material coming from the cooler 4.

In the cooler 4, the polymeric material coming from the extruder 2 may be subjected to relative high cooling speeds, for example higher than or equal to 5° C./min. In one embodiment, the speed of cooling of the polymeric material in the cooler 4 may be higher than or equal to 10° C./min.

Adopting relatively high cooling speeds has important consequences, particularly in the case in which the polymeric material is an amorphous polymer.

In fact, using high cooling speeds, the glass transition temperature T_{g} of the amorphous polymer decreases relative to that which would be achieved with lower cooling speeds, as previously described with reference to FIG. 5 and to Tables 1 and 2. That means that, in the curve of FIG. 3, by increasing the cooling speed in the stretch P3 (that is to say, the gradient of the stretch P3) it is possible to have lower temperatures in the stretch P4. In other words, by quickly cooling the material in the cooler 4, it is possible to decrease the glass transition temperature and consequently to decrease the working temperature T₂ which the polymeric material has in the mixer 7 and while it is shaped. In fact, the working temperature T₂ is a predetermined quantity higher than T_{g}, for example 50° C., so that a decrease in T_{g} also makes it possible to decrease T₂.

Moreover, by adopting relatively high cooling speeds in the cooler 4, the viscosity of the polymeric material is lower than that which would be achieved if the polymeric material were to be slowly cooled, as previously described with reference to FIGS. 6 and 7. That allows the composite material to be kept fluid enough, and therefore allows it to be formed, even if relatively low temperatures are reached in the cooler 4, and therefore even if the composite material is worked at a relatively low working temperature T₂.

At the outfeed of the mixer 7, an outfeed duct 9 is provided which ends with an outlet, from which a continuous flow of composite material comprising the polymeric material, the material of natural origin and any additives comes out, at a temperature substantially equal to the temperature T₂ (or T_{2(A)} or T_{2(B)}).

The outlet may be defined by the outfeed section of a nozzle placed at the end of the outfeed duct 9.

In the example shown, the outlet is directed upwards, so that the flow of the compound comes out of the outlet in a substantially vertical upward direction. However, this condition is not necessary, and the outlet could be oriented differently from what is shown in FIGS. 1 and 2. For example, the outlet could be oriented in such a way that the flow of composite material comes out of the outfeed duct 9 in a substantially vertical downward direction, or in a substantially horizontal or inclined direction.

The apparatus 1 also comprises at least one separating element 11 or separator for separating from the continuous flow of composite material coming out of the outlet a dosed quantity or dose 12 of composite material. The dose 12 corresponds to the quantity of compound necessary to form an object.

The apparatus 1 also comprises at least one conveying element 13 or conveyor for moving a dose 12 away from the outlet.

In the example shown, the separating element 11 is an edge of the conveying element, particularly a lower edge of the conveying element 13, which passes over the outlet to scrape from the outlet the quantity of composite material which came out during the interval between two consecutive passes of the conveying elements 13. However, this condition is not necessary, since it is also possible to use separating elements 11 different from what is shown in FIG. 1, for example a single blade which moves independently of the conveying element 13.

The apparatus 1 also comprises a pressing device which includes at least one mould 14 for forming an object from a dose 12. The mould 14 is configured to form the object from the dose 12 by means of compression moulding.

The mould 14 may comprise a first half-mould 15 and a second half-mould 16, movable one relative to the other along a moulding line D, which in the example shown is vertical, between an open position Q1 and a closed position Q2.

In the open position Q1, the first half-mould 15 and the second half-mould 16 are at a distance from each other, so that a dose 12 of composite material can be released between the first half-mould 15 and the second half-mould 16. Moreover, in the open position Q1 it is possible to remove from the mould 14 an object which has already been formed.

In the closed position Q2, the first half-mould 15 and the second half-mould 16 are near each other, in such a way that between the first half-mould 15 and the second half-mould 16 a closed forming chamber is defined, having a shape corresponding to the shape of the object.

In the example shown, the first half-mould 15 is a female half-mould having a cavity and the second half-mould 16 is a male half-mould comprising a punch. The female half-mould is positioned below the male half-mould, in such a way that the dose 12 is released into the cavity of the female half-mould. However, this condition is not necessary and, in an alternative embodiment not shown, the male half-mould could be positioned below the female half-mould, in such a way that the dose 12 is released onto an upper surface delimiting the punch.

Moreover, the first half-mould 15 and the second half-mould 16 could be positioned in such a way that the moulding line D is not vertical. The moulding line D could for example be horizontal, or oblique.

The conveying element 13 is movable along a path, which may be a closed path, for example but not exclusively circular, in such a way as to pick up a dose 12 which the separating element 11 has separated from the continuous flow of composite material and to convey the dose 12 towards the mould 14.

In the example shown, there is a plurality of conveying elements 13 which are movable along the closed path. The conveying elements 13 may be supported by a conveying carrousel 17, rotatable about an axis of rotation Y which may for example be vertical.

When the conveying element 13 is interposed between the first half-mould 15 and the second half-mould 16 of a mould 14 positioned in the open position Q1, the dose 12 is released by the conveying element 13 onto the half-mould below and the conveying element 13 returns towards the outlet of the duct 9 to pick up a new dose 12.

In the example shown, there is a plurality of moulds 14, which are movable along a closed path which may be circular. The moulds 14 may for example be mounted in a peripheral region of a moulding carrousel 18, rotatable about an axis Z which may be vertical.

During operation, one or more polymeric materials, for example in the form of pellets, are inserted into the extruder 2. Here the polymeric material is heated and melted until it reaches a maximum extrusion temperature T₁ which, in the case of a semi-crystalline polymer, is higher than the melting temperature T_{f} of the crystalline fraction, as well as the glass transition temperature T_{g} of the amorphous fraction. If the polymeric material is an amorphous polymer, in the extruder 2 a temperature T₁ of the polymeric material is reached which is at least 80° C. higher than the glass transition temperature, the temperature being intended to subsequently be lowered before adding the material of natural origin.

Downstream of the extruder 2, the polymeric material is cooled in the cooler 4. The temperature of the polymeric material reached in the cooler 4 is lower than the maximum temperature which the polymeric material reached in the extruder 2, but is in any case higher than the glass transition temperature of the polymeric material (if amorphous) or than the crystallisation temperature of the crystalline fraction, if the polymeric material is a semi-crystalline polymer.

After having cooled the polymeric material, it is possible to add the material of natural origin and/or one or more additives. The material of natural origin and/or the additives are added to the polymeric material after the temperature of the latter has been decreased in the cooler 4, in such a way as to reduce the risks of damaging the material of natural origin and/or the additives due to high temperatures.

The compound obtained by adding to the polymeric material the material of natural origin and/or one or more additives is then mixed to make its composition homogeneous, for example in the twin-screw extruder 8.

In this way a fluid flow of composite material is obtained from which it s possible to separate the doses 12, by means of cutting or scraping. Each dose 12 is then conveyed towards a mould 14 and released into the mould 14. Here the dose 12 can be compression moulded while the material which forms the dose 12 is at a temperature higher than the glass transition temperature, if the polymeric matrix of the composite material comprises an amorphous polymer, or than the crystallisation temperature of the crystalline fraction, if the polymeric matrix of the composite material comprises a semi-crystalline polymer. More specifically, the compound which forms the dose 12 is shaped between the first half-mould 15 and the second half-mould 16, which remain in the closed position Q2 until the object obtained has reached a consistency adequate for being handled without being damaged. At this point, the mould 14 is brought into the open position Q1 for extraction of the object and to receive a new dose 12. The apparatus 1 and the related operating method guarantee a wide degree of freedom in the choice of the composition of the composite material. In fact, by cooling the polymeric material before adding the material of natural origin or the additives, it is possible to use materials of natural origin which degrade at relatively low temperatures and which could not be used if they were added to the polymeric material in the extruder 2.

Similar reasoning is applicable to the additives. By adding the additives after the polymeric material has been cooled, the range of additives usable is broadened, since it is even possible to use heat-sensitive additives which would be damaged if added to the polymeric material while the latter is heated to a high temperature, as is the case in the extruder 2.

The apparatus 1 and the related operating method also increase the flexibility in the composition of the object as regards the quantity of additives used. For example, one of the additives used in extrusion is the plasticiser, which may even be used to avoid reaching temperatures which are too high during extrusion. By cooling the polymeric material in the cooler 4 before adding the material of natural origin and/or the additives, it is possible to reduce the quantity of plasticiser or even to avoid its use. In fact the cooling to which the polymeric material is subjected in the cooler 4 makes the temperatures reached in the extruder 2 substantially unimportant, in terms of the risk of damaging the material of natural origin and/or the additives.

The apparatus 1 and the related operating method allow objects to be made which have limited environmental impact compared with objects made entirely with synthetic polymeric materials, with high productivity.

In particular, in the apparatus 1 the objects are made in line with production of the composite material, since the mixer 7 in which the composite material is created by mixing the material of natural origin with the polymeric material is positioned in line with the pressing device. In this way, the composite material directly feeds the pressing device, without being cooled to ambient temperature in advance.

The pressing device may comprise a moulding carrousel as in the case shown in FIGS. 1 and 2, or a plurality of moulds positioned with a linear or matrix arrangement, or even a single mould in a fixed position.

In any case, forming by pressing, for example compression moulding, allows orientation of the macro-molecules or chains of the polymeric material and also the fibres of the material of natural origin, so as to obtain an object made of composite material which has relatively high level mechanical properties.

Moreover, if the polymeric material intended to form the polymeric matrix is a semi-crystalline polymer, the crystalline fraction may be affected by the Flow Induced Crystallisation phenomenon, on the basis of which the high speeds reached by the polymeric material inside the apparatus 1 cause an increase in the crystallisation of the crystalline fraction. In this way, the mechanical properties of the object formed are further improved.

1. A method for making an object with a composite material comprising at least one polymeric material in which a material of natural origin is dispersed, wherein the method comprises the steps of:
extruding the polymeric material in an extrusion stage;
adding the material of natural origin to the polymeric material, thereby obtaining the composite material;
pressing the composite material to obtain the object,
wherein the material of natural origin is added to the polymeric material after having cooled the polymeric material downstream of the extrusion stage.

2. The method according to claim 1, wherein the object is a packaging component.

3. The method according to claim 1, wherein the object is a concave object.

4. The method according to claim 1, wherein the polymeric material comprises a semi-crystalline polymer which includes an amorphous fraction and a crystalline fraction, and wherein the material of natural origin is added to the polymeric material while the polymeric material is at a temperature higher than or equal to the crystallisation temperature of the crystalline fraction.

5. The method according to claim 4, wherein in the extrusion stage, the semi-crystalline polymer is heated to an extrusion temperature which is higher than the melting temperature of the crystalline fraction.

6. The method according to claim 1, wherein the polymeric material comprises an amorphous polymer having a glass transition temperature, and wherein the material of natural origin is added to the polymeric material while the polymeric material is at a working temperature higher than the glass transition temperature of the amorphous polymer.

7. The method according to claim 6, wherein in the extrusion stage, the amorphous polymer is heated to an extrusion temperature which is at least 80° C. higher than the glass transition temperature of the amorphous polymer.

8. The method according to claim 1, and furthermore comprising the step of mixing the composite material obtained by adding the material of natural origin to the polymeric material.

9. The method according to claim 1, wherein the polymeric material is cooled downstream of the extrusion stage with a cooling speed higher than or equal to 5° C./minute.

10. The method according to claim 1, wherein the step of pressing the composite material to obtain the object comprises cutting a continuous flow of composite material to obtain a dose of composite material, and shaping the dose by compression in a mould to obtain the object.

11. The method according to claim 1, wherein the material of natural origin comprises cellulose in the form of fibres or powder.

12. An apparatus for making an object with a composite material comprising at least one polymeric material in which at least one material of natural origin is dispersed, wherein the apparatus comprises:
an extrusion stage for extruding the polymeric material;
a cooler positioned downstream of the extrusion stage for cooling the polymeric material;
a metering unit positioned downstream of the cooler for adding the material of natural origin to the polymeric material which has been cooled, thereby obtaining the composite material;
a mixer for mixing the composite material;
a pressing device for pressing the composite material, so as to obtain the object.

13. The apparatus according to claim 12, wherein the mixer comprises a twin-screw extruder.

14. The apparatus according to claim 12, wherein the pressing device comprises a mould for moulding the object by compression moulding.

15. The apparatus according to claim 14, and furthermore comprising a separating element for separating a dose of composite material from a continuous flow of composite material coming from the cooler.

16. The apparatus according to claim 15, and furthermore comprising a conveying element movable along a path for conveying the dose towards the mould.

17. The method according to claim 1, wherein the object is selected from a group consisting of a closing element for a container, a container, a capsule, and a preform for a container.

18. The method according to claim 6, wherein the working temperature is at least 50° C. higher than the glass transition temperature of the amorphous polymer.

19. The method according to claim 8, wherein the mixing step occurs in a twin-screw extruder.

20. The method according to claim 9, wherein the polymeric material is cooled downstream of the extrusion stage with a cooling speed higher than or equal to 10° C./minute.
